(19) United States
(12) Patent Application Publication
(10) Pub. No.: US 2010/0053205 A1
(43) Pub. Date: Mar. 4, 2010

(54) METHOD, APPARATUS, AND SYSTEM FOR DISPLAYING GRAPHICS USING HTML ELEMENTS

(76) Inventor: Debra Brandwein, Los Angeles, CA (US)

Correspondence Address: STETINA BRUNDA GARRED & BRUCKER, 75 ENTERPRISE, SUITE 250, ALISO VIEJO, CA, 92656, US

(21) Appl. No.: 12/203,506

(22) Filed: Sep. 3, 2008

(51) Int. Cl. G09G 5/00

(52) U.S. Cl. 345/619

(57) ABSTRACT

A method, apparatus, and system for redefining a graphic in a web browser using HTML elements are disclosed. The method begins with requesting the graphic from a data source. The method continues by obtaining graphic data from the data source, the graphic data including at least one primitive defining the graphic. Thereafter, the method continues by mapping the primitive on a grid coordinate system defining a grid, the grid having a plurality of grid elements, each grid element representing pixel values on the web browser. The method continues by determining a filled grid area value for each grid element based upon a portion of the primitive filling each grid element. Subsequently, the method continues by processing the filled grid area values to determine an opacity value for each grid element. The method finishes by using the opacity values to create HTML elements defining the graphic. In accordance with various aspects of the present invention, a computer readable medium such as a software program may redefine the graphic in a web browser using HTML elements. Additionally, a system is provided having various components in a client server configuration that may run the software program to redefine a graphic using HTML elements.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to the field of computer graphics, and more particularly to a method, apparatus, and system for displaying computer graphics using HTML elements.

2. Related Art

The Internet has blossomed from a medium for simple data exchange and messaging to the fastest growing, most innovative medium for information exchange and commerce. Virtual shopping malls, buying services, and other types of Internet-based retailing methods are being employed by an ever increasing number of retail merchants and consumers alike. With this reallocation of commerce being conducted over the Internet, online retailers and website owners expend vast resources to provide visually appealing and technologically efficient websites for users to access.

With the rapid rise in popularity of Internet commerce and information services, and the rapid evolution of computer and communications technologies, great strides have been made in improving the timeliness, quality, quantity, and, perhaps most importantly, the types of information that can be exchanged through the Internet. Whereas in the past, the Internet was primarily used for file transfer and exchange of text-based messages, today the Internet is routinely used for distributing elaborate, interactive, real-time graphical displays, real-time audio, and real-time video. These technological improvements greatly increase the user appeal of websites thereby generating increased traffic and greater revenues.

Distribution of such graphical content is complex and technologically demanding, as it must cater to a variety of web browsers running on different technological platforms. Today, a website may be accessed from a personal computer, mobile device, kiosk, or even by a smart system installed in a vehicle so that a user may access information in real time. Generally, a web browser is used to view a web page or to visit a web site. Electronic display devices may have varying screen sizes but still use a web browser. For example, Apple Inc.'s iPhone mobile device and Apple Inc.'s personal computer allow users to access web pages through the Safari web browser. However, individual web pages may be adapted so that the graphics are rendered in accordance to the screen size and memory capabilities of each device.

Therefore, it is critical for computer graphics to be rendered in accordance with the technical specifications of a display device. Graphics rendering refers generally to the process of generating a two-dimensional graphic from graphical models. A graphical model defines attributes of a real or imaginary object which are to be represented in a rendered graphic. These attributes include, for example, color, shape, and position of an object in a graphics scene. In the process of rendering these models, a graphics system generates a display graphic, which typically includes an array of pixel data. A pixel is a point or picture element in a display device, and in the context of graphics processing, also corresponds to a point in the two dimensional space to which the graphical models are rendered. The pixel data of a rendered graphic includes one or more data values describing attributes of a pixel used to display it. For instance, this pixel data can include intensity values for color components. These intensity values are then used to display the array of pixels comprising a graphic on a physical output device such as a monitor.

In the rendering process, the geometric primitives corresponding to objects in a scene are processed to generate a graphic. The rendering process typically begins by transforming the vertices of the geometric primitives to prepare the model data for rasterizing. Rasterizing generally refers to the process of computing a pixel value or values for a pixel in the view space based on data from the geometric primitives that project onto or “cover” the pixel. Rasterizing is sometimes referred to as “tiling” because of the analogy to tiling a floor. Imagine that the pixels are square elements or tiles, and that a geometric primitive, such as a circle, is the floor plan. Rasterizing includes “tiling” this floor plan by computing pixel values for the pixels or “tiles” within the primitive.

A technique known as antialiasing is used to represent continuous surfaces between discrete pixels. In general, antialiasing is used to compute pixel intensities for partially covered pixels to reduce the discontinuities introduced by representing a continuous object with a discrete array of pixels. Web browsers in different display devices employ rendering and antialiasing techniques in accordance with screen size, resolution, and other attributes, as pixel values vary accordingly.

In order to expedite the loading of the web page, a plug in or third party script may run on the client side to rasterize and antialise the graphic so that it may be rendered in the web browser. However, such third party applications are often prohibited from running behind a firewall or may compromise memory capacities. Additionally, these applications require additional computational complexity that consumes more processing resources. For real time systems with limited processing power, such as mobile devices or hand held devices, the computations required for these approaches makes them untenable alternatives for maintaining consistency amongst websites.

Therefore, maintaining consistent websites having the same graphical content for various applications when viewed in a web browser is difficult to accomplish. Another common work around is for developers to create alternate versions of websites having limited graphics and content for limited memory applications. Generally, users are dissuaded from visiting such watered down versions of the website as they lack the content rich appeal that originally drew the user to web site in the first place.

Accordingly, there is currently a need in the art for an improved method, apparatus, and system for displaying computer graphics.

### BRIEF SUMMARY

In accordance with the present invention, there is disclosed a method, computer readable medium apparatus, and system for redefining a graphic using Hyper Text Markup Language (HTML) elements. It will be appreciated that the present invention redefines or redraws a graphic so that it may be rendered upon any web browser. Additionally, it is contemplated that a web browser stored on any computing device such as a computer, mobile device, handheld PC, video game system, and the like, may render the redefined graphic.

The method may begin by requesting a graphic from a data source. The data source may be any web server, database, or the like. The graphic may be an image embedded within a web page or file, or a stand alone image or graphic. The method may continue by obtaining graphic data from the data source, the graphic data including at least one primitive defining the graphic. The graphic may be a vector graphic. Vector graphics include the use of geometrical primitives such as points, lines, Bezier curves, and shapes or polygons, to represent graphics in computer graphics.

The method may continue by mapping the primitive on a grid having a plurality of grid elements, each grid element representing pixel values. The method may continue by determining a filled area value for each grid element based upon a portion of the primitive filling each grid element. The filled area value may be calculated by performing geometric equations to compute a mathematical representation of the portion of the primitive encompassing each grid element. The method may continue by processing the filled area values to determine an opacity value for each grid element. An opacity value is conventionally utilized in HTML to determine the resolution of particular text or graphics displayed by the HTML code. In this regard, by correlating opacity to the filled area value of each grid element the resolution of the graphic is precisely identified. As a result, the graphic may be antialiased or smoothed out when rendered on the web browser. This feature is particularly useful when rendering any curvature such as a border of the graphic.

The method continues by using opacity values to create HTML elements defining the graphic. HTML elements are an organizational structural of HTML code that is used to represent text and images in documents and web pages. The opacity values may be processed to redefine the dimensions, position, and any other attributes of the graphic in the HTML elements. It is contemplated that the HTML elements may be programmed in a file such as a web page or the like, and the web browser may compile the file thereby rendering the graphic.

It is further contemplated that the graphic data may include any data defining the primitive so that the graphic may be precisely redefined in the HTML elements. In an exemplary embodiment of the present invention, the graphic data may include a background color value and a foreground color value for the primitive. The background and foreground color values may be processed to derive a final color value for each grid element.

Upon programming the HTML elements in the file, the HTML elements may be compiled by a program module such as web browser or the like, subsequently rendering the graphic thereupon. Additionally, it will be appreciated that the graphic may be redefined solely through HTML elements and therefore there is no requirement for complex memory hoarding programs or third party applications to represent the redefined graphic.

In another embodiment of the present invention, there are provided computer executable instructions such as software, firmware, or the like, for redefining a graphic using HTML elements. The computer executable instructions may be scripted in any computer readable programming language including, but not limited to, XML, Java, Visual Basic or the like. It is contemplated that the computer executable instructions may be run on any computer processing device such as computer, laptop, network server, mobile device, handheld PC, and the like.

In yet another embodiment of the present invention, a system for redefining a graphic in using HTML elements is provided. The system may include a server, such as a web server or the like, having a blueprint software program creates a blueprint of the graphic by mapping the graphic to a grid and determining a filled area value of the graphic relative to the grid. It is contemplated that the blueprint may be stored on the web server or in the application cache of a client computer. The blueprint may be transmitted to a client computer via a network. The client computer may have a HTML software program operable to determine opacity values representing the graphic by processing the filled area values of the blueprint. Additionally, the HTML software program may correlate the opacity values with the filled area values to subsequently create HTML elements redefining the graphic.

It is contemplated that the architecture of the system may consist of a client/server design so that the blueprint is created on the back end server side and transmitted to the client side where the HTML elements are generated. In another embodiment, the blueprint software program and the HTML software program may be stored on the web server so that a graphic redefined in HTML elements is transmitted to the client.

It will be appreciated that the present method, computer program apparatus, and system provide an efficient and low cost approach to displaying computer graphics on a web browser. Additionally, it is advantageous that the present invention is applicable to any web browsers.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating a system environment of an embodiment of the present invention, the system having a client computer, a web server, and a network for transmitting data between the client and server.

FIG. 2 is an exploded view of client computer illustrating the various components of the computer in accordance with various aspects of the present invention.

FIG. 3 is a flow diagram illustrating the steps in the method of rendering a graphic using HTML elements within a web browser.

FIG. 4 illustrates a primitive mapped to a two dimensional grid in accordance with various aspects of the present invention, the primitive being a circle.

FIG. 5 is a section view of the primitive mapped on the grid coordinate system in FIG. 4, and further illustrating portions of the primitive filling the grid elements and intersecting points of the primitive upon the grid.

Common reference numerals are used throughout the drawings and the detailed description to indicate the same elements.

### DETAILED DESCRIPTION

The detailed description set forth below in connection with the appended drawings is intended as a description of one presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

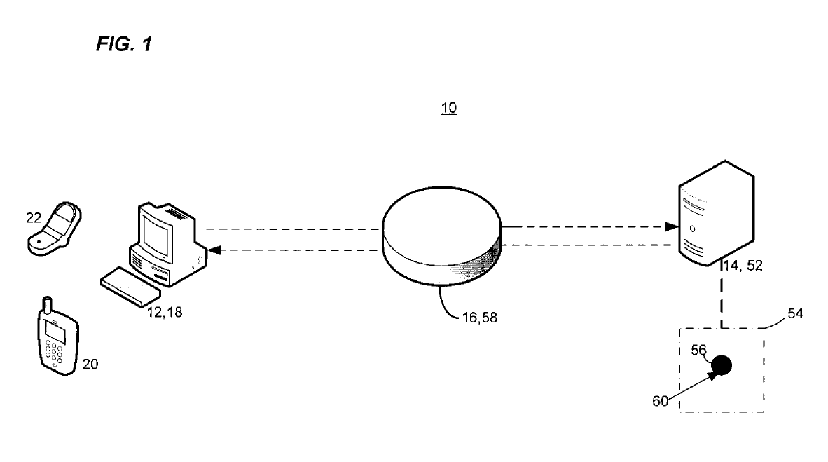

In accordance with one aspect of the present invention, there is provided a method, system, and computer readable medium apparatus for redefining a graphic using HTML elements. The present invention redefines and redraws a graphic or an image in HTML elements and subsequently renders the graphic on a web browser. FIG. 1 illustrates an example of a system 10 for redefining a graphic in HTML elements in accordance with various aspects of the present invention. The system 10 represents a client server computing environment on which the present invention may be implemented. The client server computing environment includes a client computing device 12, a server computing device 14, and a network 16. The client server computing environment is only one example of a suitable computing environment for the system 10 and is not intended to suggest any limitation as to the scope of use or functionality of the invention. Neither should the client server computing environment be interpreted as having any dependency or requirement relating to any one or combination of components illustrated.

The invention may be described in the general context of computer executable instructions, such as software or firmware, being executed by components of the system 10. Generally, computer executable instructions include routines, programs, objects, components, data structures, and so forth, which perform particular tasks or implement particular abstract data types. The invention may also be practiced in distributed computing environments where the tasks are performed by remote processing devices that are linked through a communications network 16. In a distributed computing environment, computer executable instructions may be located in both local and remote computer storage media including memory storage devices.

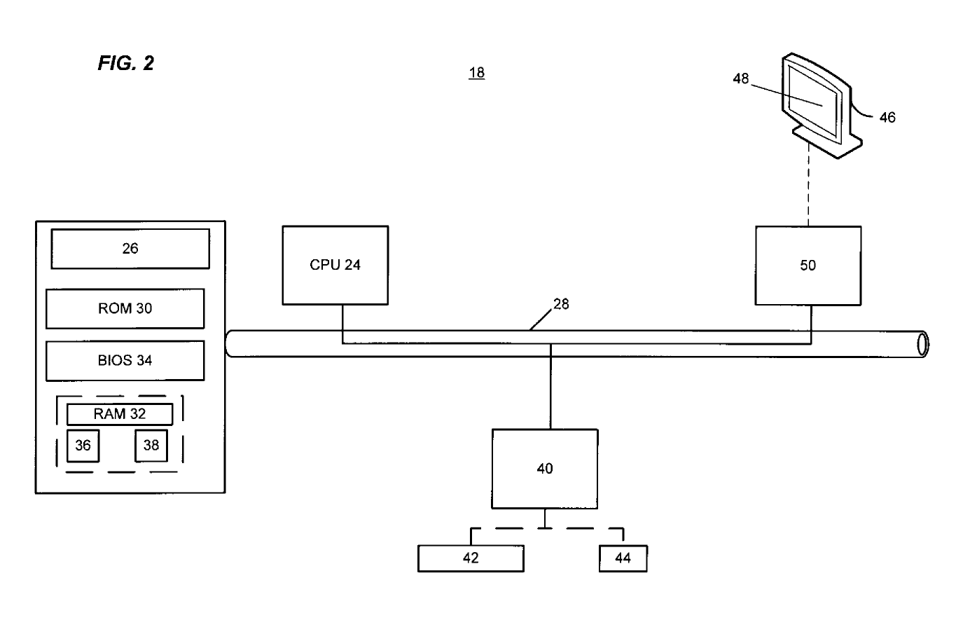

With reference to FIGS. 1 and 2, an exemplary system 10 for implementing the invention includes a client computing device 12 in the form of a computer 18. However, the present invention is operational with numerous other general purpose or special purpose computing devices, environments or configurations. Examples of well known client computing devices 12 that may be suitable for use with the invention include, but are not limited to, handheld PCs 20 or laptop devices, mobile devices 22, video gaming systems, and the like. Components of the computer 18 may include, but are not limited to, a computer processing unit (CPU) 24, a system memory 26, and a system bus 28 that couples various components including the system memory 26 to the CPU 24. The computer 18 typically includes a variety of computer-readable media. Computer-readable media can be available media that can be accessed by the computer 18 and includes both volatile and nonvolatile media, and removable and non-removable media. By way of example, and not limitation, computer-readable media may comprise computer storage media. Computer storage media includes, but is not limited to, RAM, ROM, EEPROM, flash memory, or other memory technology, CD-ROM, digital versatile disks (DVD) or other optical disk storage or other magnetic storage devices, or any other storage medium.

The system memory 26 includes computer storage media in the form of volatile and/or nonvolatile memory such as read only memory (ROM) 30 and random access memory (RAM) 32. A basic input/output system (BIOS) 34, containing the basic routines that help to transfer information between elements within the computer 18, such as during start-up, is typically stored in ROM 30. RAM 32 typically contains data and/or program modules 36, such as a web browser 38, client side scripts, and the like, that are immediately accessible to and presently being operated on by the CPU 24. In the present embodiment, the computer 18 has at least one web browser 38. Examples of well known web browsers 38 include Microsoft Inc.'s Internet Explorer, Apple Inc.'s Safari, Opera Software ASA's Opera web browser, the Mozilla Foundation's Firefox, and the like. It is contemplated that any web browser 38 may be utilized by the present invention.

The computer 18 has a user input interface 40 connected to the system bus 28 to process any data entered through an input device. A user may enter commands and information into the computer 18 through input devices such as a keyboard 42 and mouse 44. Other input devices may include a microphone, a joystick, game pad, satellite dish, scanner, a touch-sensitive screen of a handheld PC 20 or other writing tablet, and the like. A monitor 46 having a display screen 48, or some other type of display device is also connected to the system bus 28 through an interface, such as a video interface 50. It is contemplated that client computing devices 12 may have varying display screen 48 sizes having different screen resolutions. Generally, a computer 18 may have a larger display screen 48 than does a mobile device 22 or handheld PC 20. In this regard, the present invention is capable of redefining a graphic for applications with having varying display screen 48 sizes and screen resolutions.

The system 10 provides a networked environment for the computer 18 to operate in using logical connections to one or more remote client computing devices 12, or the server computing device 14. In the present embodiment, the server computing device 14 is a web server 52. However, it is contemplated that the server computing device 14 may be any computing device such as a computer 18, a network server, a network PC, a peer device, a mobile server, or the like, and typically includes many or all of the elements described above relative to the computer 18. A web server 52 may store or host a variety of graphics or files having graphics, such as a website or a web page. In the present embodiment, the web server 52 stores a web page 54 having a graphic 56 embedded thereupon. The logical connections depicted in FIG. 1 include a network 16. In the present embodiment, the network 16 is the Internet 58. A person having ordinary skill in the art, however, will understand that any telecommunications modality such as a wireless network, radio frequency network, proprietary closed networks, or the like, may be employed to establish a communicative connection between the computer 18 and the web server 52. A computer 18 and web server 52 in an Internet 58 environment generally include a modem or other means for establishing communication.

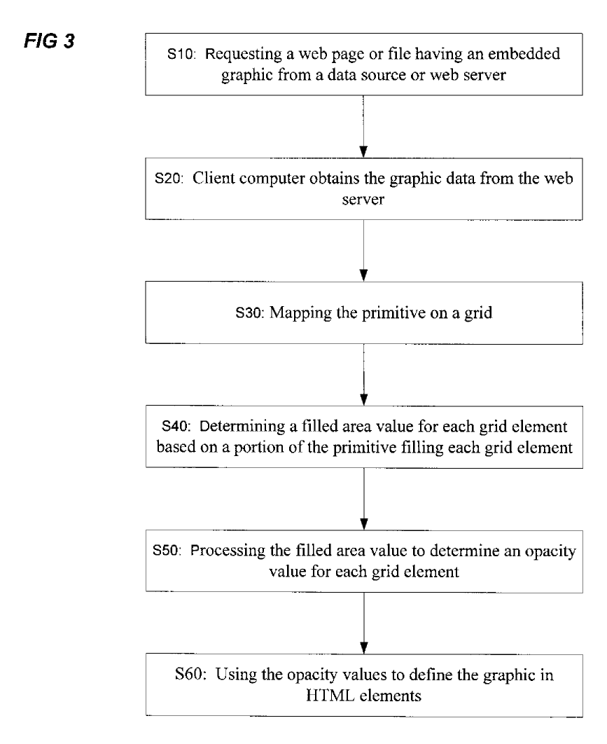

FIG. 3 is a flow diagram illustrating the actions that may occur when redefining a graphic using HTML elements. Now referring to FIGS. 1-5, the method initiates at S10 when the computer 18 requests a graphic. In the present embodiment, the computer 18 includes a web browser 38 which requests the web server 52 to transmit via the Internet 58 a web page 54 having a graphic 56 embedded thereupon. Such a request is generally made through Hypertext Transfer Protocol (HTTP). A person having an ordinary skill in the art, however, will recognize that any communications protocol may be utilized to request or receive the data through the Internet 58.

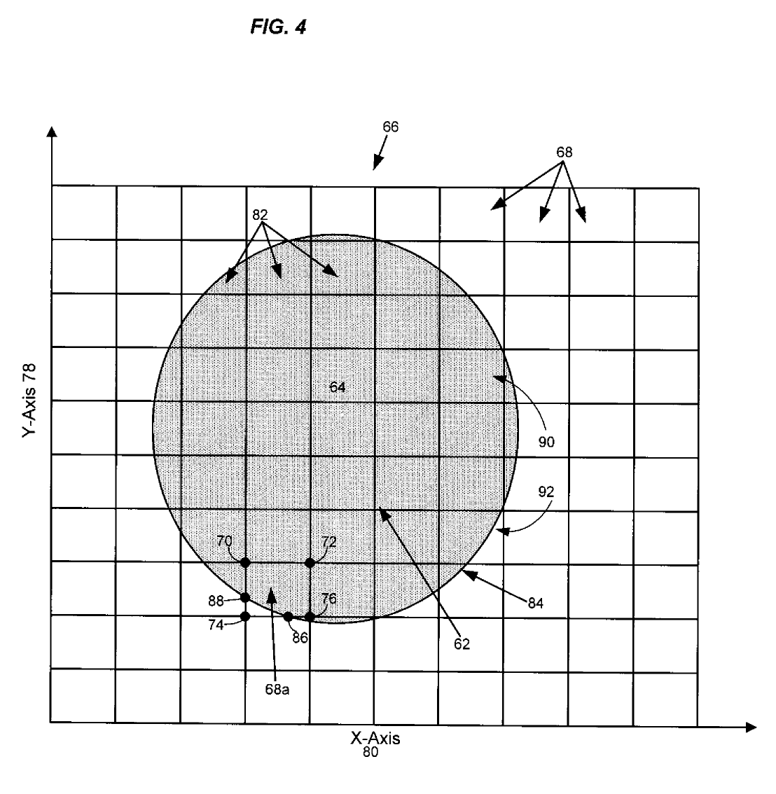

Subsequent to receiving the HTTP request for the web page 54, the web server 52 sends a response to the computer 18. This response comprises of graphic data 60 representing the web page 54 and the graphic 56 embedded thereupon. At S20 the user obtains the graphic data 60 from the web server 52 via the Internet 58. The graphic data 60 includes at least one primitive 62 defining the graphic 56. In the present embodiment, the graphic 56 is a vector graphic. However, it is contemplated that any graphics including raster graphics and the like may be redefined by the present invention. Vector graphics include use of geometrical primitives 62 such as points, lines, Bezier curves, and shapes or polygons, which are all based upon mathematical equations, to represent images in computer graphics. An image or graphic 56 may be comprised of multiple primitives 62. Additionally, it is contemplated that the present invention may incorporate a vector drawing software to translate vector commands into primitives 62. By way of example, a vector command may be “draw a red house.” Subsequently, vector drawing software may transform the vector command into a series of primitives 62 representing the house, including lines, shapes, points, and data representing the color red. In the present embodiment, a circle 64, as illustrated in FIG. 4, represents the primitive 62 defining the graphic 56.

The method continues at S30 by mapping the primitive on a grid 66. The grid 66 includes a plurality of grid elements 68. FIG. 4 illustrates a primitive 62 mapped on the grid 66 in accordance with various aspects of the present invention. In the present embodiment, the grid 66 is two dimensional having a horizontal X axis 78 and a vertical Y axis 80. However, it is contemplated that the grid 66 may be multi dimensional including additional axes such as a Z axis for mapping three dimensional graphics. The technique of mapping the primitive 62 on a grid 66 is known in the art as rasterizing. Therefore, the graphic 56 transmitted to the computer 18 is transformed into a raster graphic. In the present embodiment, the grid 66 has one hundred grid elements 68. However, the grid 66 may comprise any number of grid elements 68. Each grid element 68 is associated with the pixel values of the display screen 48. In the present embodiment, the grid elements 68 and pixel values have a one to one relationship. However, it is contemplated that the grid elements 68 may have any type of association with pixel values including a many to one, one to many relationship, and the like.

The method continues at S40 by determining a filled area value 82 for each grid element 68 based on a portion of the primitive 62 filling each grid element 68. In the present embodiment, the filled area value 82 is a mathematical representation of the portion of the primitive 62 that encompasses each grid element 68. The filled area value 82 may be computed through geometric equations performed upon data associated with the primitive 62 mapped on the grid 66.

In the present embodiment, each grid element 68 is represented as a square having four corners, a top left corner 70, a top right corner 72, a bottom left corner 74, and a bottom right corner 76. However, it is contemplated that a grid element 68 may be represented by any shape, size, or form. If the primitive 62 entirely encompasses all four corners 70-76 of the grid element 68, the primitive 62 fills the grid element 68. However, if any corner 70-76 of the grid element 68 is not entirely encompassed by the primitive 62, the primitive does not fill the grid element 68.

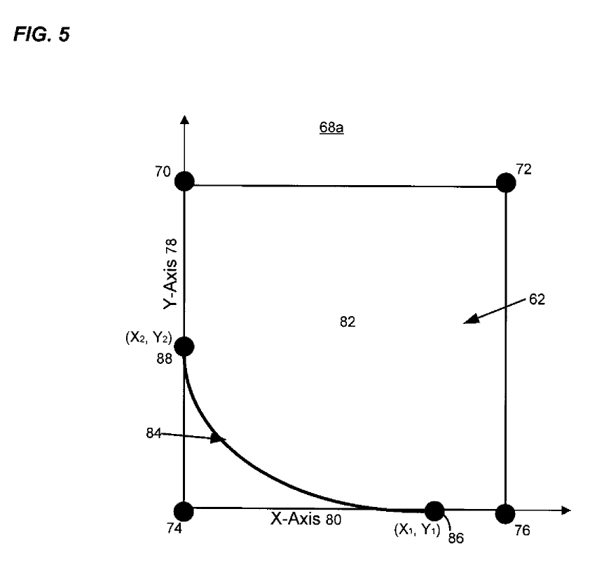

Now referring to FIG. 4, the border 84 of the circle 64 intersects through various grid elements 68. As a result, that the primitive 62 is not entirely encompassing certain grid elements 68. One specific example of a grid element 68 intersected by the border 84 and being partially encompassed by the primitive 62 is grid element 68a. Specifically, the primitive 62 does not encompass the bottom left corner 74 of the grid element 68a. The border 84 intersects through the grid element 68a at intersecting points 86, 88. FIG. 5 illustrates a section view of the grid 66 highlighting grid element 68a. The intersecting points 86, 88 are identified according to their position of the grid 66. In the present embodiment, the intersecting points 86, 88 have the coordinates: (x₁, y₁) 86 and (x₂, y₂) 88.

Now referring to FIGS. 1-5, The filled area value 82 of grid element 68a may be determined by processing the intersecting points 86, 88. An exemplary equation provided for determining the filled area value 82 for grid element 68a is provided:

filled area value=(x−r)²+(y−r)²=r²

In the exemplary equation, the r value represents the radius of the circle 64. The exemplary equation is only one example of determining a filled area value 82 and is not intended to suggest any limitation as to the scope of use or functionality of the invention. In this regard, it is contemplated that a primitive 62 may be any point, line, shape, or curve, including Bezier curves, polygons, and the like. Therefore, a person having ordinary skill in the art will understand that the appropriate quadratic function or geometric equation would be employed to determine the filled area values 82.

The method continues at S50 by processing the filled area value 82 to determine an opacity value (not shown) for each grid element 68. An opacity value is conventionally utilized to determine the resolution of particular text or graphic 56 embedded in a web page 54. In the present embodiment, a grid element 68 and a pixel have a one to one relationship. Therefore, the opacity value for each pixel may be determined by the present invention. By accurately processing the opacity value for each pixel, the graphic 56 will be antialised or smoothed out in various resolutions on different client computing devices 12.

In the present embodiment, opacity values are correlated to grid elements 68. In this regard, each grid element 68 that is entirely encompassed by the primitive 62 has an opacity value of 1. Each grid element 68 that is partially encompassed by the primitive 62, such as grid element 68a, has an opacity value equal to the filled area value 82 for that grid element 68, which is less than 1.

It is contemplated that any attribute defining the graphic 56 may be programmed in the HTML elements to redefine the graphic 56 including, but not limited to, size, color, opacity, shape, and the like. In the present embodiment, the foreground 90 and background color 92 values of the primitive 62 are computed to determine a final color value for each grid element 68. As there is a one to one relationship between grid elements 68 and pixel values, the present invention may determine the final color value for each pixel rendering the graphic 56. In the present embodiment, the final color value for a grid element 68 may be derived the following exemplary equation:

Final Color=Background Color−Opacity*(Background Color−Foreground Color)

In the exemplary equation, the final color value is determined by associating attributes including opacity, foreground color 90, and background color 92. However, a person having ordinary skill in the art will recognize that the final color value for a grid element 68 may be derived using numerous associations of any attribute alone or in combination thereof and therefore the exemplary equation is provided by way of example and in no way serves to limit the scope of the invention.

The method finishes at S60 by using the opacity values to create HTML elements defining the graphic 56. In the present embodiment, the HTML elements are created in a file that may be viewed by the web browser 38. The attributes defining the graphic 56 may be stored in data structures. In the present embodiment the opacity values for each grid element 68 are stored in an array. However, a person having an ordinary skill in the art will understand that any data structure may be utilized to store opacity values including linked lists, hash tables, integers, characters, matrices, and the like. Table 1 provides an exemplary array storing the opacity values of the primitive 62.

TABLE 1
$[ \begin{matrix}.029 & .576 & .943 & .943 & .576 & .029 \\ .576 & 1 & 1 & 1 & 1 & .576 \\ .943 & 1 & 1 & 1 & 1 & .943 \\ .943 & 1 & 1 & 1 & 1 & .943 \\ .576 & 1 & 1 & 1 & 1 & .576 \\ .029 & .576 & .943 & .943 & .576 & .029\end{matrix} ]$

The exemplary array displayed in Table 1 illustrates the opacity value of each grid element 68 according to the position of the grid element 68 on the grid 66. Therefore, the grid elements 68 intersected by the border 84 have opacity values less than one and the grid elements 68 entirely encompassed by primitive 62 have a value of 1. Generally, it is difficult to antialise a border 84, or any curvature associated with a primitive 62. The present invention advantageously determines the precise opacity values of the border 84 relative to each grid element 68. As a result, an antialised border 84 may be rendered.

In the present embodiment, the opacity value array is programmed in the HTML elements via a computer executable instruction, such as a software program. By way of example, and not limitation, an exemplary software program function that programs the HTML elements is provided:

```
Function createHTML( arr, color, bgcolor ) {
    Var html = new Array( );
    Var hex = “0123456789ABCDEF”;
    Var color_r = 16*hex.indexOf(color.charAt(0))+hex.indexOf(color.charAt(1));
    Var color_g = 16*hex.indexOf(color.charAt(2))+hex.indexOf(color.charAt(3));
    Var color_b = 16*hex.indexOf(color.charAt(4))+hex.indexOf(color.charAt(5));
    Var bgcolor_r =
    16*hex.indexOf(bgcolor.charAt(0))+hex.indexOf(bgcolor.charAt(1));
    Var bgcolor_g =
    16*hex.indexOf(bgcolor.charAt(2))+hex.indexOf(bgcolor.charAt(3));
    Var bgcolor_b =
    16*hex.indexOf(bgcolor.charAt(4))+hex.indexOf(bgcolor.charAt(5));
    For ( var i=0; i<arr.length; i++ ) {
    For ( var j=0; j<arr[i].length; j++ ) {
    Var grid_val = arr[i][j];
    var mix_r = bgcolor_r − grid_val*(bgcolor_r − color_r);
        var mix_g = bgcolor_g − grid_val*(bgcolor_g − color_g);
        var mix_b = bgcolor_b − grid_val*(bgcolor_b − color_b);
        var mixed_color = hex.charAt(mix_r/16) + “” + hex.charAt(mix_r%16) + “”
    + hex.charAt(mix_g/16) + “” + hex.charAt(mix_g%16) + “” +
    hex.charAt(mix_b/16) + “” + hex.charAt(mix_b%16);
        Html.push( “<div
    style=position:absolute;top:”+i+”px;left:”+j+”px;width:1px;height:1px;background-
    color:#”+mixed_color+”></div>” );
        }
      }
      return html.join(“”);
    }
```

In the exemplary software program function, the opacity value and background color value 92 are the only attributes of the primitive 62 provided to create the HTML elements defining the graphic 56. However, a person having an ordinary skill in the art will understand that any attributes of the primitive 62 may be used to create HTML elements defining the graphic 56. The variable j represents the X axis 78 and the variable i represents the Y axis 80. Therefore, the opacity values are programmed relative to the position of each grid element 68 on the grid 66.

Similarly, the background color values 92 are processed according to their association with the grid elements 68. The exemplary software program function translates the background color value 92 from a HEX variable into an RGB (red, green, blue) color value. Additionally, the colors of the primitive 62 are mixed to ascertain a precise representation of the graphic 56. A person having ordinary skill in the art will recognize that the exemplary software program function is provided by way of example and in no way serves to limit the scope of the invention. Additionally, a variety of algorithms, logic, variables, and the like may be incorporated into a computer executable instruction to program data in the HTML elements.

Subsequent to the graphic 56 being redefined in the HTML elements, the web browser 38 compiles the HTML elements so that the graphic 56 is rendered thereupon. In the present embodiment, the web browser 38 uses a document object model (DOM) to render an HTML element. A DOM is a platform and language independent standard object model for representing HTML. In the present embodiment, in order to be visible on the web browser 38, the graphic 56 needs to be attached to the DOM and positioned relative to its container element or to other objects within the container element. It is contemplated that any HTML element or tag may be utilized as a container element or as elements within a container element. In the present embodiment, a <BODY> element and a <DIV> element are used to define the graphic 56 in the HTML elements. Additionally, a <DIV> element has a style attribute or a style sheet which can be used to set the position of the graphic 56, such as absolute or relative, and further set the dimensions of the graphic 56 such as top, left, width, and height, and may further set additional attributes such as color, opacity, and the like. A style sheet may be programmed inline so that it is embedded directly in the HTML code. Alternatively, a style sheet may be programmed as a cascading style sheet (CSS) which allows style information from several sources to be blended together. It is further contemplated that the style sheet may be programmed dynamically by calling an object or by using a class name. A person having ordinary skill in the art will recognize that any HTML tags or style sheets may be used alone or in combination thereof to define the graphic 56 in accordance with various aspects of the present invention.

It will be appreciated that the graphic 56 may be redefined in HTML elements stored in a file such as a web page, or the like, and requires no additional scripts to redraw the graphic 56. In this regard, an HTML representation of the graphic 56 generally requires minimal memory and processing power to render. Therefore, the present invention may be employed to redefine a graphic 56 in a variety of limited memory systems while still providing the consistent content rich appeal found on other applications hosting the same graphic 56. Additionally, it is contemplated that any proprietary file browser that can read HTML elements may be utilized in accordance with various aspects of the present invention to render or display the graphic 56.

In another embodiment of the present invention, a computer readable medium having computer executable instructions is provided for redefining a graphic in HTML elements. In the present embodiment, the computer executable instructions are a software program. However, it is contemplated that the computer executable instructions may be embodied as firmware or the like. The software program may be written in any computer readable language such as XML, Java, Visual Basic, and the like, that are compatible with web browsers 38. In the present embodiment, the software program is a Java script. It is contemplated that the software program may be installed on the computer 18 or on the web server 52. Alternatively, the software program may be hosted on any third party component residing on or off the network 16.

In another embodiment of the present invention, the system 10 may be designed so that various aspects of redefining a graphic 56 using HTML elements are performed various components of the system 10 running multiple software programs. In a first exemplary embodiment, the web server 52 includes a blueprint software program that defines a blueprint of the graphic 56. A blueprint includes mathematical data defining the graphic 56. In the present embodiment, the blueprint includes the filled area values 82 of the graphic 56 as mapped on a grid 66. It is contemplated that the blueprint may be stored on the web server 52 or the in the application cache or RAM 26 of the computer 18. The blueprint is subsequently transmitted to the computer 18 via the Internet 58. The computer 18 has a HTML software program that processes the blueprint and computes an opacity value according to each filled area value 82. The HTML software program may process the opacity values to create HTML elements redefining the graphic 56. It is contemplated that the HTML elements may be created in a file stored in the system memory 26. The distributed design of this embodiment shares the computational resources of the computer 18 and the web server 52.

In a second exemplary embodiment, the web server 52 may store the blueprint software program and the HTML software program. As a result, the web page 54 is transmitted to the computer 18 having the graphic 56 redefined in HTML elements. Consequently, the computer 18 does not need to expend any additional computational processing power to redefine the graphic 56. This embodiment may be advantageous in applications having limited memory or limited processing power including but not limited to, mobile devices 22, handheld PCs 20, video game systems, and the like.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for redefining a graphic using Hyper Text Markup Language (HTML) elements, the method comprising the steps of:
requesting the graphic from a data source;
obtaining graphic data from the data source, the graphic data including at least one primitive defining the graphic;
mapping the primitive on a grid coordinate system defining a grid, the grid having a plurality of grid elements;
determining a filled grid area value for each grid element based upon a portion of the primitive filling each grid element;
processing the filled grid area values to determine an opacity value for each grid element; and
using the opacity values to create HTML elements defining the graphic.

2. The method of claim 1 wherein the graphic data further includes a foreground color value of the primitive.

3. The method of claim 2 wherein the graphic data further includes a background color value of the primitive.

4. The method of claim 3 wherein the step of using opacity values to create HTML elements further includes:
using the foreground color value, the background color value, and the opacity value to determine a final color value for each grid element.

5. The method of claim 4 further including the steps of:
deriving a first intermediate color value by subtracting the foreground color value from the background color value;
deriving a second intermediate color value by multiplying the first intermediate color value with the opacity value; and
deriving the final color value by subtracting the second intermediate color value from the background color value.

6. The method of claim 5 wherein the final color values are set in the HTML elements.

7. The method of claim 1 wherein the filled grid area values are determined by geometric equations.

8. The method of claim 1 wherein the step of using the opacity values to determine HTML elements further includes:
defining the dimensions of the graphic in the HTML elements.

9. The method of claim 1 further including the step of:
creating the HTML elements in a file.

10. The method of claim 9 wherein the file is a web page having a source code and the HTML elements are created in the source code.

11. The method of claim 10 further including:
compiling the source code to render the graphic on a web browser.

12. The method of claim 11 wherein the grid elements represent pixel values of the web browser.

13. A computer readable medium having computer-executable instructions for redefining a graphic using Hyper Text markup Language (HTML) elements, comprising:
instructions for retrieving graphic data from a data source, the graphic data including at least one primitive defining the graphic;
instructions for mapping the graphic data over a grid coordinate system defining a grid, the grid coordinate system having a plurality of grid elements;
instructions for determining a filled grid area value for each grid element based upon a portion of the primitive filling each grid element;
instructions for processing the filled grid area value to determine an opacity value for each grid element; and
instructions for using the opacity values to create HTML elements defining the graphic.

14. The computer readable medium of claim 13 wherein the graphic data further includes a foreground value color value of the primitive.

15. The computer readable medium of claim 14 wherein the graphic data further includes a background value color value of the primitive.

16. The computer readable medium of claim 15 wherein the instructions for using the opacity values to create HTML elements further includes:
instructions for using the foreground color value, the background color value, and the opacity value to determine a final color value for each grid element.

17. The computer readable medium of claim 16 further including:
a first intermediate color value being determined by subtracting the foreground color value from the background color value;
a second intermediate color value being determined by multiplying the first intermediate color value with the opacity value; and
the final color value being determined by subtracting the second intermediate color value from the background color value.

18. The computer readable medium of claim 17 wherein the final color values are set in the HTML elements.

19. The computer readable medium of claim 13 wherein the filled grid area values are determined by geometric equations.

20. The computer readable medium of claim 13 wherein the instructions for using the opacity values to determine HTML elements further includes:
instructions for defining the dimensions of the graphic in the HTML elements.

21. The computer readable medium of claim 13 further includes instructions for creating HTML elements in a file.

22. The computer readable medium of claim 21 wherein the file is a web page having a source code and the HTML elements are created in the source code.

23. The computer readable medium of claim 22 further including instructions for compiling the source code to render the graphic in a web browser.

24. The computer readable medium of claim 23 wherein the grid elements represent pixel values of the web browser.

25. A system for redefining a graphic using Hyper Text Markup Language (HTML) elements, the system comprising of:
a blueprint processor including:
memory to store graphic data, the graphic data including at least one primitive defining the graphic; and
a blueprint software program operative to map the graphic data on a grid coordinate system defining a grid, the grid having a plurality of grid elements, each grid element having a filled grid area value based upon the portion of the primitive filling the grid element;
a HTML processor including:
memory to store the graphic data transmitted by the blueprint processor; and
a HTML software program operative to process the filled grid area values for determining an opacity value for each grid element, the HTML software program being operative to use the opacity values to create HTML elements defining the graphic;
a network for transmitting data between the blueprint processor and the HTML processor.

26. The system of claim 25 wherein the blueprint processor includes the HTML software program.

27. The system of claim 25 wherein the HTML processor includes the blueprint software program.

28. The system of claim 25 wherein the graphic data further includes a foreground color value.

29. The system of claim 28 wherein the graphic data further includes a background color value.

30. The system of claim 29 wherein the blueprint software program processes the foreground color value, the background color value, and the opacity values to determine a final color value for each grid element.

31. The system of claim 30 wherein the blueprint software program further includes:
a first intermediate color value being determined by subtracting the foreground color value from the background color value;
a second intermediate color value being determined by multiplying the first intermediate color value with the opacity value; and
the final color value being determined by subtracting the second intermediate color value from the background color value.

32. The system of claim 31 wherein the HTML software program sets the final color value in the HTML elements.

33. The system of claim 25 wherein HTML software program processes the opacity values for determining the dimensions the graphic and sets the dimensions in the HTML elements.

34. The system of claim 25 wherein HTML software program creates the HTML elements on a file stored on the HTML processor.

35. The system of claim 34 wherein the file is a web page having a source code and the HTML elements are created in the source code.

36. The system of claim 35 wherein the HTML processor includes a web browser for compiling the source code and rendering the graphic on the web browser.

37. The system of claim 36 wherein the grid elements represent pixel values of the web browser.
